(19) United States
(12) Patent Application Publication
(10) Pub. No.: US 2004/0118090 A1
(43) Pub. Date: Jun. 24, 2004

(54) TIRELESS SADDLE

(76) Inventor: Stacey Ann Landfield, Warner Springs, CA (US)

Correspondence Address: Stacey Ann Landfield, 37559 Cruces Dr, Warner Springs, CA, 92086, US

(21) Appl. No.: 10/329,154

(22) Filed: Dec. 23, 2002

(51) Int. Cl. B68G 1/00

(52) U.S. Cl. 54/44.7

(57) ABSTRACT

A gel saddle (20) comprising of a gel seat (15) that is attached to stirrup riggings (92) which lie under skirts (44). Seat (15), skirts (44) and stirrup riggings (92) are attached to gel seat cushion (57) and rest on flaps (18). Flaps (18) cover girth straps (73) which are on top of sweat flaps (62) and all are attached and rest upon gel panels (10). Panels (10) rest on each side of the spine of the animal (400) creating an open space or gullet (17) over the spine of the animal (400). A girth (47) connects to one side of the girth straps (73) encircle the animal (400) and connects to the other side of girth straps (73).

### CROSS REFERENCE TO RELATED APPLICATIONS

Not applicable

### BACKGROUND

1. Field of Invention

This invention is an animal saddle which is treeless and pliable

2. Discription of Prior Art

Humans have, in the past used all types of methods of support or saddles to help them remain on animals they are riding. Saddles, in the past, have had some form of “tree” or rigid material which helps support the human riding the animal such as in U.S. Pat. No. 4,771,590 Bates 1986, U.S. Pat. No. 4,502,266 Friedson 1983, U.S. Pat. No. 4,965,988 Anderson 1989 and U.S. Pat. No. 4,265,075 Motsenbocker 1979.

The problems with rigid trees are numerous. Upon examining past saddle patents it becomes apparent that the tree of the saddle causes most problems for human and animal.

Tree problems:

1. The tree forms a bridge over the animal's back which focuses the weight of the rider into small “pressure points” as shown in FIG. 1. These pressure points over time become sore for the animal.

2. The shoulder blade or scapula of the animal swings back and forth with movement. With a conventional saddle this movement is hampered as each time the scapula is in the “back” position it hits the tree of the saddle as shown in FIG. 1.

3. A rigid tree can be uncomfortable for a rider during the movement of the animal.

4. Rigid trees are not safe in the event of an accident. Rider or animal are prone to injury should one or both crush against the saddle, as for instance, in a fall.

5. When ridden down hill, the saddle tree digs into the shoulders of the animal as illustrated in FIG. 2.

6. A rigid tree cannot follow the movement of the ever changing shape of an animal's back. The back will change shape during the raising and lowering of the animal's head. The animal will raise and lower its head during normal movement such as: walking, trotting, galloping, jumping, stopping or going up and down hill as shown in FIGS. 3 and 4.

7. While an animal bends laterally a conventional saddle tree will dig into the sides of the animal as shown in FIG. 5.

With U.S. Pat. No. 3,888,070 White 1975 we have a tree that is flexible. This is an improvement over a rigid tree although weight distribution and pressure points will still be a problem. The scapula will also hit the tree if the animal is ridden down hill.

In U.S. Pat. No. 5,383,328 Brown 1993 we have a saddle where the panels can be adjusted for a more custom fit for the animal. This still does not solve the problem since we know that the shape of an animal's back changes with movement.

With U.S. Pat. No. 5,187,924 Marshall 1991 the problem of lateral movement has been addressed by having a flexible material between a front and a back tree. This does not alleviate the problems of weight distribution, pressure points and the fact that going down hill the tree will jab into the animal's shoulders.

In U.S. Pat. No. 862,572 Maussner 1907 we have a riding device that has detachable stirrups so the device can be used as a normal pad under a conventional saddle. This device is more of a bareback pad than a saddle as it provides no support for a human as it has no cantle. It also is made out of curled hair so the comfort level would be low. This device would not be suited for formal riding nor could it be made into various styles to accommodate different riding fashions.

In U.S. Pat. No. 3,286,440 Walker 1966 we have a saddle where the main concern is for it to be lightweight. The saddle has a fork which is the front part of a tree and this would give us the problems discussed earlier.

In U.S. Pat. No. 3,872,653 Thompson 1975 we have a bareback riding device with riggings for a girth and stirrups. In this riding device there is rigid gripping members which would cause the animal discomfort.

With U.S. Pat. No. 3,312,040 Nuzzo 1965 we have a saddle with riggings for stirrups and a girth. This saddle has no open space or gullet over the spine of the animal which could lead to problems as the weight of the rider falls on the spine of the animal during movement. Also there is a bar for holding onto that could be a danger in the event of an accident.

Many pads have been invented to try to alleviate the pain that a saddle with a tree will cause such as U.S. Pat. No. 5,119,618 Streck 1992 and U.S. Pat. No. 4,683,709 Vasko 1987.

The comfort and safety of both human and animal must be taken into consideration. Also with the fact that many people who exhibit their animals need special riding attire to compete in their various riding fashions. With the modern substances now available such as silicone, rheopexic fluid, foam, polyurethane, nylon different forms of gel and the like, a saddle can be made which is comfortable for both animal and human. With modern fabrics this saddle can be made to be durable and fashionable. Eliminating the tree and using a gel substance will greatly increase the comfort of both animal and human. Providing a gullet or a space over the spine of the animal will protect the animal's spine.

The entire saddle could be injection molded out of polyurethane or the like with a simulated leather design. The saddle could be bonded with a mechanical thermal bond of like materials. Polyurethane or other pliable substances with varying levels of durometer could be used accordingly for greater comfort and strength.

### SUMMARY

In accordance with the present invention, an animal saddle made of a pliable substance such as polyurethane, silicone, rheopexic fluid, air, creaton or the like, leaving an open space or gullet over the spine of the animal.

### OBJECTS AND ADVANTAGES

Accordingly several objects and advantages of this saddle are:

(a) Being treeless and pliable this saddle does not create pressure points on an animal's back as a conventional saddle will do. Pressure points will many times lead to soreness and can make an animal unable to be ridden.

(b) This saddle being treeless and pliable conforms to the movement of the animal thus not inhibiting the freedom of movement for the animal as a saddle with a tree will do.

(c) This saddle being treeless and pliable distributes weight over a broad area creating more comfort for the animal.

(d) This saddle being treeless and pliable will give the rider more “feel” of the animal which is very important in many riding disciplines.

(e) This saddle being treeless and pliable will be very comfortable for the rider.

(f) This saddle can be made into the fashions and styles that riders require for their individual riding disciplines.

(g) This saddle is substantially safer than a conventional saddle in the event of an accident where rider or animal may crush against it.

(h) This saddle can be made with various pliable materials at different levels of pliability.

(i) This saddle can be made with various forms of seats to fit different human body types.

(j) The pliable material used may be air.

(k) The components of this saddle may be made to be interchangeable or replaceable.

(l) Different materials could be used to encase the pliable material with varying colors

(m) A pliable material could be used with no encasement

(n) This saddle may be made to fit different sized animals

Further objects and advantages are to provide a means of support for a human riding an animal that is safe and comfortable for human and animal and fashionable as well.

Also to provide a riding situation that enables the rider to have more “feel” for the animal being ridden. Still further objects and advantages will become apparent from a consideration of the ensuing description and drawings.

### DRAWING FIGURES

FIG. 1 Side elevation showing prior art with movement of animal's scapula and pressure points created.

FIG. 2 Side elevation showing animal moving down hill with prior art and pressure points created.

FIG. 3 Side elevation showing animal with head raised creating hollowed back.

FIG. 4 Side elevation showing animal with head lowered creating rounded back.

FIG. 5 Top elevation with animal bending laterally carrying prior art.

FIG. 6 Cross section of a gel panel

FIG. 7 Side elevation of a gel saddle

FIG. 8 Bottom elevation of a gel saddle

FIG. 9 Exploded perspective view of a gel saddle

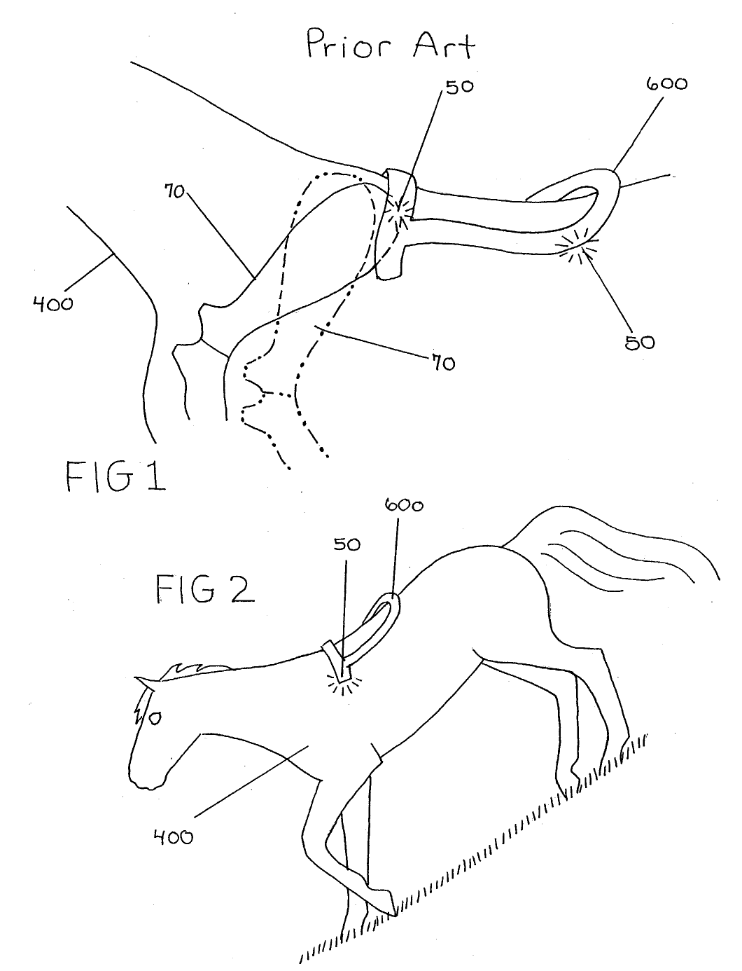

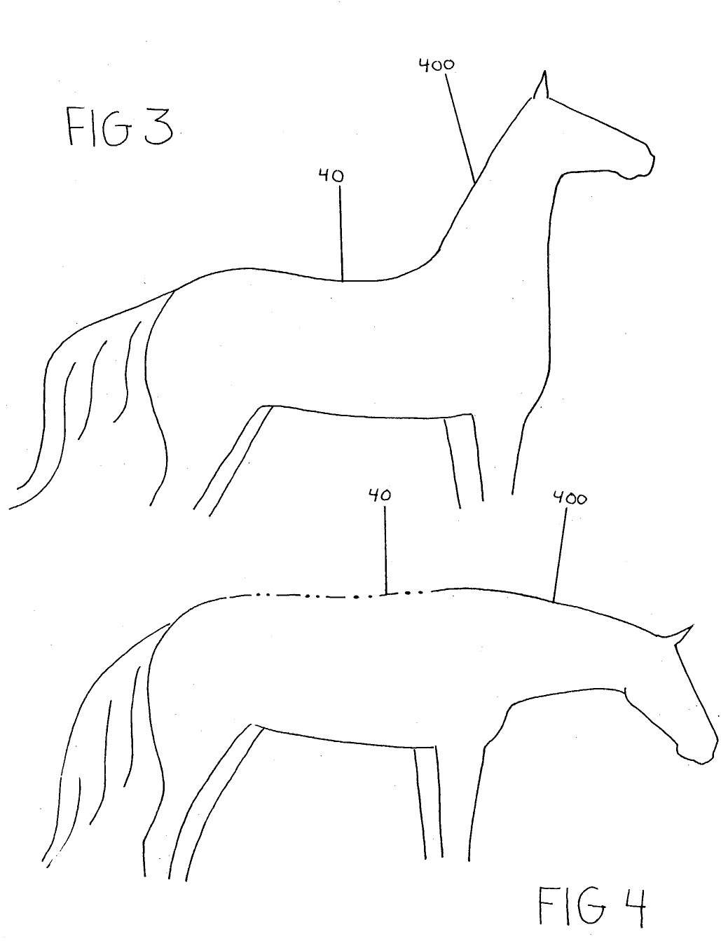

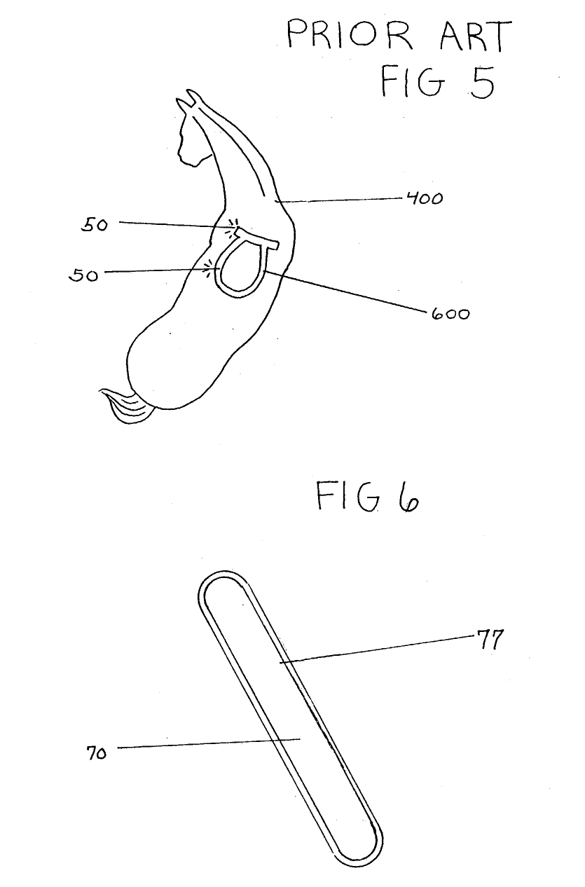

### REFERENCE NUMERALS IN DRAWINGS

400 animal

70 scapula

50 pressure points

600 conventional saddle tree

40 back of animal

60 pommel

20 gel saddle

15 gel seat

12 cantle

18 flap

10 gel panels

44 skirt

17 gullet

62 sweat flap

73 girth straps

92 stirrup rigging

47 girth

57 gel seat cushion

70 gel

77 casing

### DISCRIPTION

FIG. 6 is an illustration of a cross section of a gel panel 10 showing gel 70 encased in material 77.

Referring to FIG. 7 an illustration of a gel saddle 20 showing a gel seat 15 having a cantle 12 and a pommel 60. A skirt 44 is attached to seat 15. Underneath skirt 44 is a flap 18 and both are attached to a seat cushion 57 which is also attached to gel seat 15. Seat cushion 57 lies on top of and is attached to gel panels 10. All elements are connected to each other to form one unit as shown in FIG. 9.

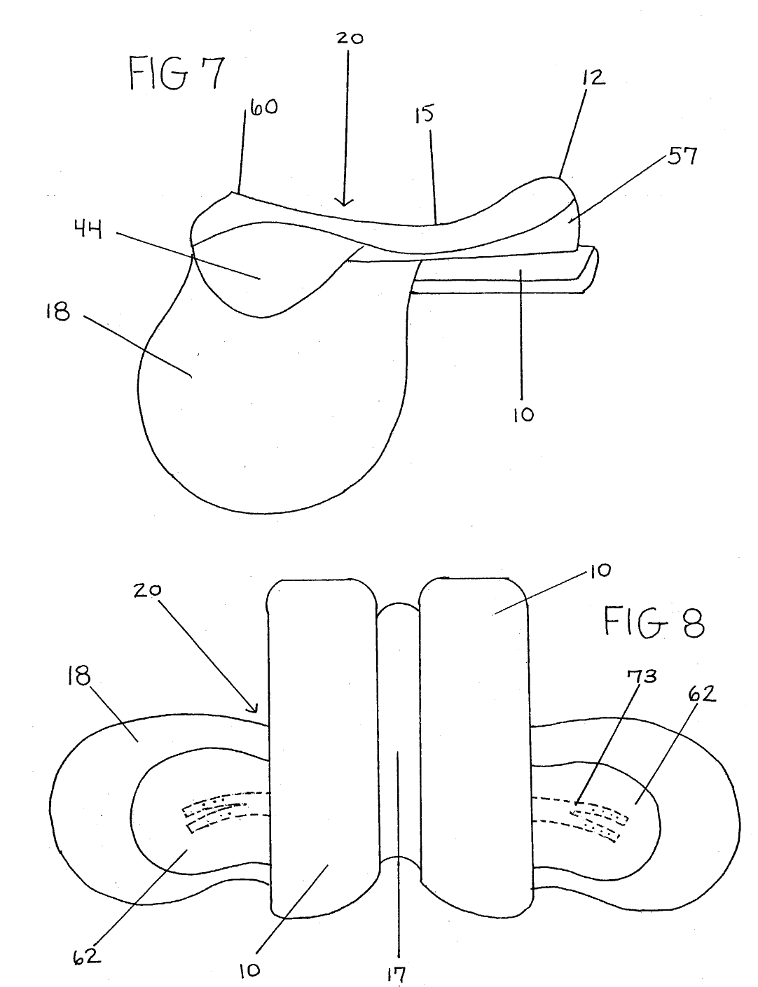

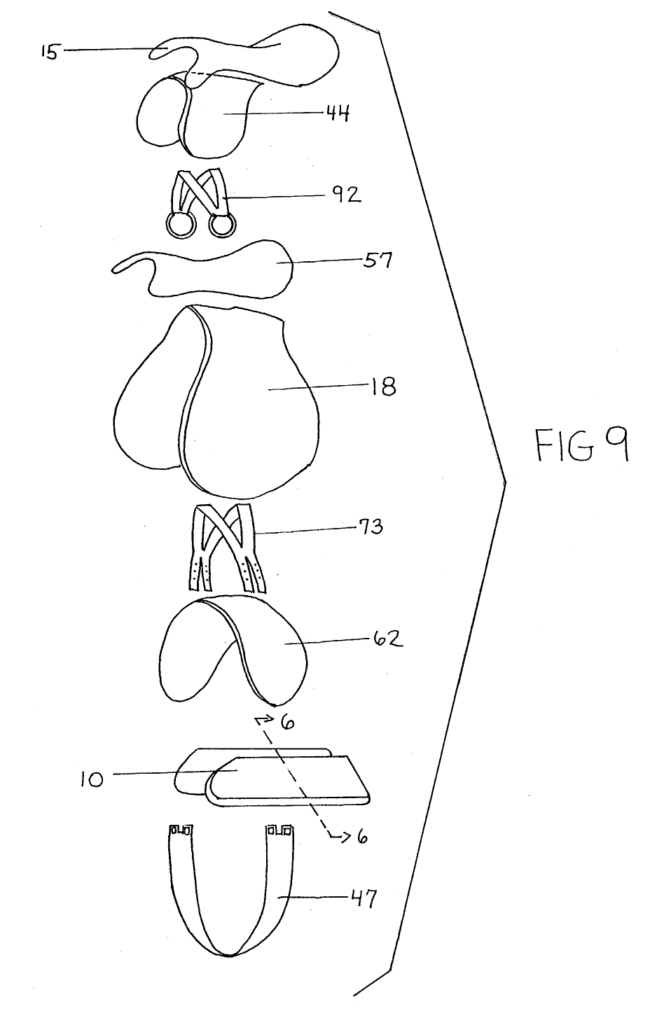

Referring to FIG. 8 a bottom view of a gel saddle 20 showing gel panels 10 forming an open space or gullet 17. Gel panels 10 are attached to sweat flaps 62. On top of sweat flaps 62 are girth straps 73. Girth straps 73 are sandwiched between sweat flaps 62 and skirt 18.

FIG. 9 shows an exploded perspective elevation of a gel saddle 20. A gel seat 15 is on top of and attached to a skirt 44. Skirt 44 is attached to a stirrup rigging 92. Conventional stirrups (not shown) are attached to stirrup rigging 92. Stirrup rigging attaches to top of gel seat cushion 57. Gel seat cushion 57 attaches to flap 18 which attaches to and lies on top of girth strap 73. Girth strap 73 is attached to both flap 18 and sweat flap 62. Sweat flap 62 is connected to gel panels 10 which lay on each side of animal's 400 spine creating a gullet 17.

### OPERATION

Gel saddle 20 is placed on animal 400 with gel panels 10 lying on each side of animal 400 spine creating gullet 17. A girth 47 is connected to girth strap 73 on one side of animal 400 and encircles the animal 400 then connects to the other side of girth strap 73 fastening all to animal 400.

### CONCLUSION, RAMIFICATIONS AND SCOPE OF INVENTION

Thus the reader will see that the saddle invented here will provide a safe and gentle means of riding an animal. The saddle being treeless and pliable affords freedom of movement for the animal. The saddle being treeless and pliable provides comfort for human and animal. The saddle distributes the rider's weight over a broad area of the animals back eliminating pressure points that conventional saddles create. While the description contains some specificities, these should not be construed as limitations on the scope of the invention, but rather as an exemplification of one preferred embodiment thereof. Many other variations are possible for example: different pliable materials can be used at different levels of pliability. Different materials may be used to encase the pliable material or no encasement at all may be used. The saddle can be made to fit different sized humans and various sized animals. This saddle can be made into various shapes, styles and colors to suit different riding fashions. The pliable material used may be air. The saddle can be made where the components are interchangeable or replaceable. A firmer substance may be used as a pliable “tree” for instance nylon or polyurethane. Different rigging styles can be used for stirrups and girth straps. Flaps and skirts could be added or subtracted to make the saddle less bulky and to serve various purposes. A pack saddle could be made with these methods and materials. Accordingly, the scope of the invention should be determined not by the embodiment illustrated but by the appended claims and their legal equivalents.

1. Equipment for riding an animal that is comfortable and safe for human and animal comprising:
a. Pliable, treeless, modern substance for a human to sit on with attached first means of support for the human's legs and feet.
b. Pliable panels to lie on both sides of said animal's spine which create a gullet or open space over the spine of said animal.
c. Second means of attachment for holding said pliable, treeless substance for human to sit on and said pliable panels to said animal

2. Equipment for riding an animal as recited in claim 1 wherein pliable substance is made of a modern substance such as: polyurethane, latex, nylon, rheopexic fluid, foam or the like.

3. Equipment used for riding an animal as recited in claim 2 wherein said pliable substance may be air.

4. Equipment used for riding an animal as recited in claim 2 wherein said pliable substance used may be of varying levels or durometer.

5. Equipment as recited in claim 2 wherein the pliable substance may be encased in a material or not encased.

6. Equipment used for riding an animal as recited in claim 1 wherein said equipment is injection molded and mechanically thermal bonded.

7. Equipment as recited in claim 1 wherein said equipment may be made into different styles, fashions, colors and textures to suit varying riding tasks and disciplines.

8. Equipment as recited in claim 1 wherein said equipment may be made into various sizes to accommodate different sizes and shapes of humans and animals.

9. Equipment as recited in claim 1 wherein said equipment may be made to have components that are interchangeable or replaceable.
